(19) United States
(12) Patent Application Publication
(10) Pub. No.: US 2014/0229569 A1
(43) Pub. Date: Aug. 14, 2014

(54) METHOD AND APPARATUS FOR SYNCHRONIZING ADDRESS BOOK IN MOBILE TERMINAL AND SERVER

(71) Applicant: SAMSUNG ELECTRONICS CO., LTD., Suwon-si (KR)

(72) Inventors: Xiaogang ZHOU, Allen, TX (US); Sia Jeffry SAPUTRA, Richardson, TX (US); Sundararajan CHELLAPPAN, Garland, TX (US)

(73) Assignee: SAMSUNG ELECTRONICS CO. LTD., Suwon-si (KR)

(21) Appl. No.: 13/763,902

(22) Filed: Feb. 11, 2013

(51) Int. Cl. H04L 29/08

(52) U.S. Cl. CPC H04L 67/1095
USPC 709/217

(57) ABSTRACT

A method and apparatus for synchronizing address book in mobile terminal and server client is disclosed. A disclosed method comprises, upon initiation of execution of an address book application in a mobile terminal, transmitting a start signal having an address book identification to an address book agent. In response to the start signal, receiving synchronization information for synchronizing an address book of the address book application, the synchronization information being generated by the address book agent in response to update information from an address book server. The method further comprises synchronizing the address book of the application using the synchronization information.

### BACKGROUND OF THE INVENTION

1. Field of the Invention

The present invention relates to a converged address book client. More particularly, the present invention relates to a method and apparatus for synchronizing address book in mobile terminal and server.

2. Description of the Related Art

Mobile terminals are developed to provide wireless communication between users. As technology has advanced, mobile terminals now provide many additional features beyond simple telephone conversation. For example, mobile terminals are now able to provide additional functions such as an alarm, a Short Messaging Service (SMS), a Multimedia Message Service (MMS), E-mail, games, remote control of short range communication, an image capturing function using a mounted digital camera, a multimedia function for providing audio and video content, a scheduling function, and many more. With the plurality of features now provided, a mobile terminal has effectively become a necessity of daily life.

A mobile terminal includes an address book for storing contact information for people that the user desires to contact. Such an address book stores different types of contact sources such as a mobile phone number, a work phone number, a word address, an Instant Messenger (IM) identifier, a social network identifier, and so forth. But because a user of a mobile terminal also uses different electronic devices (e.g., a laptop, a tablet computer, etc.) that have address books, it is difficult to keep the address book of the different devices synchronized.

A Converged Address Book (CAB) has been proposed that stores a user's personal profile and the user's address book in a network that can be accessed from any of the user's devices. Accordingly, the user's address book must be synchronized between the user's client devices and a server that manages the user's client devices. In a CAB system, a first user is able to subscribe to second user's profile as a contact in the first user's address book. If the second user edits any information about that their profile, the CAB system automatically updates the second user's information in the first user's address book. Further, in a CAB system, the first user can search for other user's published information.

As proposed, data is transferred in the CAB system in eXtensible Markup Language (XML). Thus, a CAB client includes a User Interface (UI) application that provides a user a graphical interface to use the CAB system. A CAB logic device performs the basic CAB functionality in connection with UI application.

The CAB logic device transmits and receives data from an XML processor to perform general XML processing functions associated with commands from the CAB logic device or data received from the system. The CAB client receives XML Configuration Access Protocol (XCAP) data from an XCAP client for management of XML configuration data. A Session Initiation Protocol (SIP) manager handles document subscriptions and notification services and a database stores the data in for the CAB client. The CAB client also implements a HyperText Transfer Protocol (HTTP) client for the transport of XML data.

Thus, the CAB client may be processing intensive to execute all functionality as required in CAB system.

Accordingly, there is a need for an apparatus and method for providing an enterprise converged address book client.

### SUMMARY OF THE INVENTION

Aspects of the present invention are to address at least the above-mentioned problems and/or disadvantages and to provide at least the advantages described below. Accordingly, an aspect of the present invention is to provide a method and apparatus for synchronizing address book in mobile terminal and server.

In accordance with an aspect of the present invention, a method of synchronizing an address book in a mobile terminal with an address book in a server is provided. The method includes, upon initiation of execution of an address book application in a mobile terminal, transmitting a start signal having an address book identification to an address book agent. In response to the start signal, receiving synchronization information for synchronizing an address book of the address book application, the synchronization information being generated by the address book agent in response to update information from an address book server, and synchronizing the address book of the application using the synchronization information.

In accordance with an aspect of the present invention, a method of synchronizing an address book in a mobile terminal with an address book in a server is provided. The method includes receiving a request to update at least one address book of a first user at an address book server, the request including updated contact information of a second user, determining if a mobile terminal of the first user provides an address book agent for receiving the updated contact information of the second user; and transmitting the updated contact information of the second user from the address book server to the address book agent, wherein the address book agent is configured to translate the updated contact information into a synchronization information suitable for an address book application on a mobile terminal and transmit the synchronization information to the mobile terminal in response to a user initiating execution of the address book application on the mobile terminal.

In accordance with an aspect of the present invention, an apparatus for synchronizing an address book in a mobile terminal with an address book in a server is provided. The apparatus includes a communication unit for sending and receiving data from at least one communication network, a storage unit for storing an address book and an address book application, an input unit for receiving input from a user to control the address book application, and a controller for initiating executing the address book application in response to input from the user, wherein the address book application transmits a start signal to a terminal having an address book agent in response to initiating executing of the address book application, wherein the address book agent determines if the address book needs to be synchronized with an address book in a server, and wherein the server is associated with a network entity and the terminal is associated with a different entity.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates an Converged Address Book (CAB) system according to an exemplary embodiment of the present invention;

FIGS. 2A and 2B illustrate signal flow in a CAB system implementing a Converged Address Book (CAB) agent according to an exemplary embodiment of the present invention;

FIG. 3 is a block diagram of a CAB application that implements CAB services in connection with a CAB agent according to exemplary embodiments of the present invention;

FIG. 4 is a block diagram of a CAB agent that implements CAB services in connection with a CAB application according to exemplary embodiments of the present invention;

FIG. 5 is block diagram schematically illustrating a configuration of a mobile terminal that implements a CAB application according to an exemplary embodiment of the present invention; and

FIG. 6 is a block diagram schematically illustrating a configuration of a terminal that implements a CAB agent according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

As a non-exhaustive illustration only, a terminal described herein may refer to mobile devices such as a phone, a cellular phone, a personal digital assistant (PDA), a portable lap-top Personal Computer (PC), a tablet PC, and devices such as a desktop PC, a high definition television (HDTV), like capable of wireless communication or network communication consistent with that disclosed herein.

For purposes of description of exemplary embodiments of the present invention, a terminal will hereinafter be referred to as a mobile terminal.

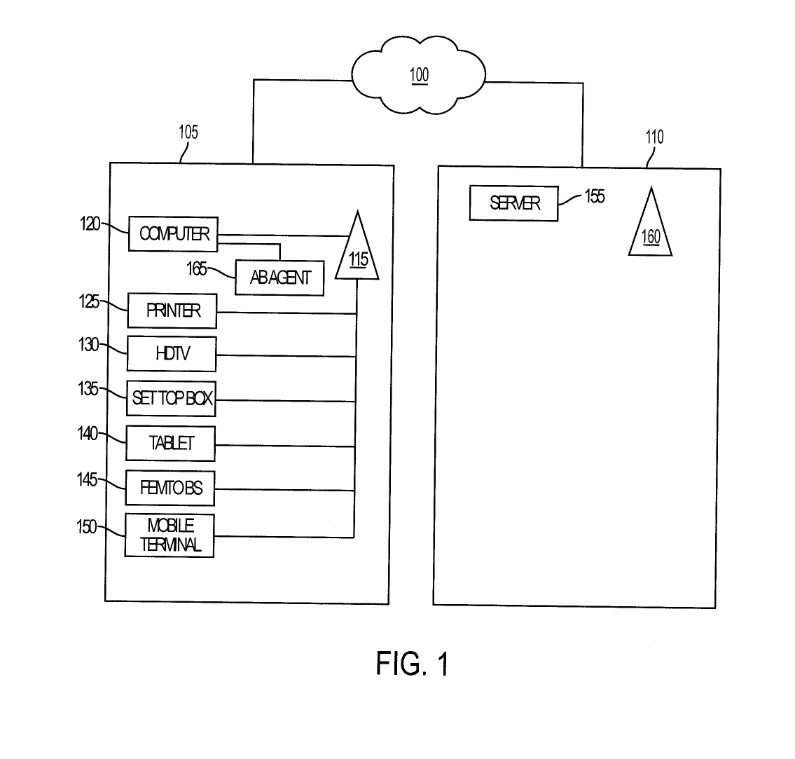

FIG. 1 illustrates an example Converged Address Book (CAB) system implementing a Converged Address Book (CAB) agent according to an exemplary embodiment of the present invention.

As will be described below, the CAB agent is operated by an entity other than a network carrier to update address book information from a device associated with a network carrier. To implement such a system, a network 100 (e.g., the Internet, etc.) connects a user domain 105 with a carrier domain 110. The user domain 105 includes an Access Point (AP) 115 that connects devices therein to the network 100. For instance, the AP 115 may be a firewall server associated with an Enterprise client or a router associated with a user's home network for connecting to the network 100. The AP 115 communicates with devices in the user domain 105 via wired and/or wireless communication interfaces such as Ethernet, Institute of Electrical and Electronic Engineers (IEEE) 802.11(n), Bluetooth®, and so forth. Generally, the devices within the user domain 105 are based on the user. In the example of FIG. 1, the AP 115 is associated with a home network of a family and includes a computer 120 (e.g., a desktop personal computer, a laptop, a server, etc.), a printer 125, a High Definition TeleVision (HDTV) 130, a set top box 135, a tablet 140, and a femto Base Station (BS) 145. The femto BS 145 is configured to enhance a user's wireless communication of a mobile terminal 150 with a wireless carrier via the AP 115. However, as noted above, the user domain 105 may be an enterprise network associated with a business entity and may comprise different devices (e.g., servers, multi-function printers, etc.).

The computer 120, the tablet 140, and the mobile terminal 150 in the user domain 105 may include an application that includes an Address Book (AB) that is synchronized with an AB stored in the carrier domain 110. For instance, the carrier domain may include a server 155 that implements a Converged Address Book (CAB) function to automatically synchronize the devices in the user domain 105 to have substantially identical ABs. Generally, upon execution of the CAB application, the CAB application receives the AB from the server 155. In another example, the CAB application receives synchronization information to synchronize the local AB with the AB stored in the server 155.

Further, the computer 120, the tablet 140, and the mobile terminal may include a CAB client that allows updates to their contact information, such as a Personal Contact Card (PCC) in the server 155, which is a document that contains the user's contact information and may be separate from the AB. The server 155 receives the updated contact information and updates the user's PCC, who can then use another device to view the changes to their PCC. Further, when the server 155 updates the user's PCC, the server 155 also updates the ABs of any other users who have subscribed to the user's PCC, thereby allowing the subscribed individuals to always have the user's most recent contact information in the PCC.

The carrier domain 110 also includes BS 160 to provide communications services to devices in the user domain 105. For example, when the mobile terminal 150 is moved outside the user domain 105, the mobile terminal 150 may communicate using the telecommunication services provided in the carrier domain 110 via BS 160. In other examples, even while in the user domain 105, the mobile terminal 150 may also communicate using the telecommunication services provided in the carrier domain 110 via BS 160. The carrier domain 110 also includes a Radio Network Controller (not shown) that controls the operations of the BS 160 and communicates with a Core Network (not shown) element that is used to transmit and receive communications with the network 100.

In the example of FIG. 1, when the mobile terminal 150 executes a CAB application, a CAB agent 165 operating on any suitable device within the user domain 105 is configured to synchronize the AB of the mobile terminal 150 with the AB of the server 155. For example, in a CAB environment, the computer 120 synchronizes its AB with the server 155. However, an AB of the mobile terminal 150 is not continuously executing to preserve processing power and network resources. The CAB agent 165 performs the CAB core functions on behalf of the mobile terminal 150 and synchronizes the mobile terminal 150 when the CAB application thereon is executed. Further, a single CAB agent 165 can be configured perform the CAB core function on behalf of a plurality of users in the user domain. For example, a business enterprise may implement a CAB agent 165 for all terminals of the enterprise to facilitate exchange of contact information, thereby simplifying management of the terminals in the enterprise.

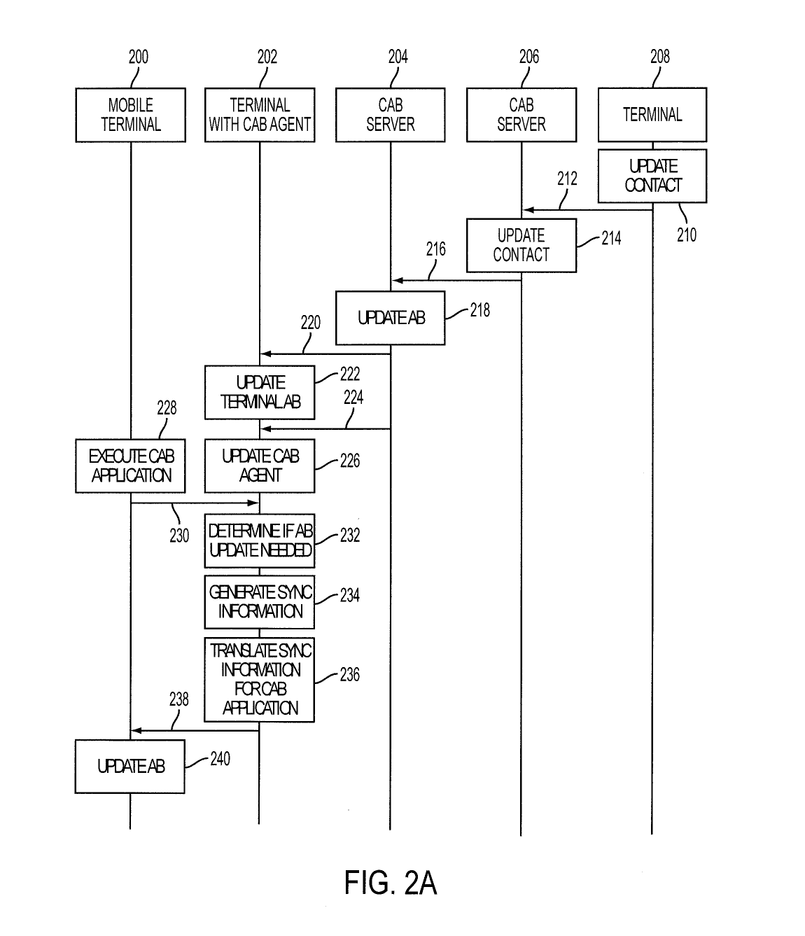

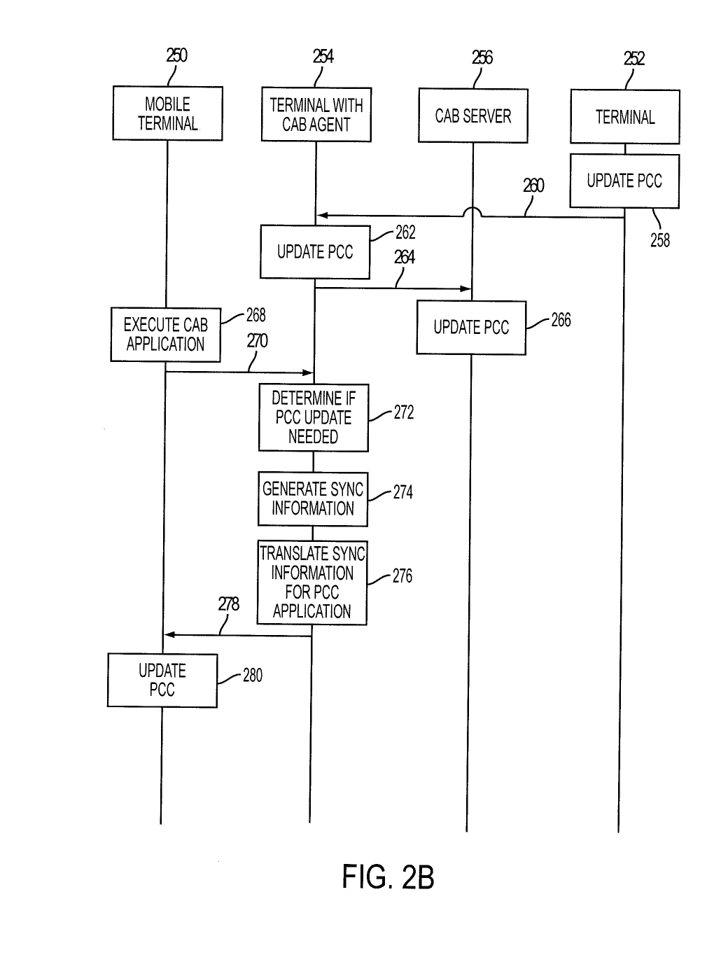

FIG. 2A illustrates a signal flow to synchronize an AB of a mobile terminal 200 of a first user who is subscribed to a second user's contact information in a CAB environment.

In this example, a terminal 202 in the user domain implements an AB with CAB core function with a CAB server 204 in a carrier domain. The terminal 202 may also execute the CAB agent to synchronize the AB of the mobile terminal 200. A CAB server 206 in another carrier domain provides similar functionality to a terminal 208 associated with the second user. For purposes of illustration, the terminal 208 and the mobile terminal 200 are subscribed to each other and receive respective AB updates.

Initially, the CAB application of mobile terminal 200 is not being executed at step 210, which is when the second user updates their contact information (e.g., address, phone number, social network identification, Instant Messenger (IM) identification, website, etc.) associated with their Personal Contact Card (PCC) in the terminal 208. In a CAB system, the user updates their Personal Contact Card (PCC) using a CAB client in the terminal 208, for example. The terminal 208 then determines a type of message to send to the CAB server 206 based on the updated contact information. For example, if the new contact information is a new contact information (e.g., a new address), the terminal 208 determines that an add message should be transmitted. If the updated contact message is changed information (e.g., an edited phone number), the terminal 208 determines that a change message should be transmitted. If the updated contact message is removed contact information (e.g., a deleted social media identifier), the terminal 208 determines that a delete message should be transmitted.

At step 212, the terminal 208 transmits an update information message to the CAB server corresponding to the determined message type. The CAB server 206 may transmit an ACKnowledgement (ACK) message back to the terminal 208 to indicate successful reception of the message. For purposes of conciseness, ACK messages and Non-ACKnowledgement (NACK) messages are not illustrated in FIG. 2. At step 214, the CAB server 206 updates the contact information of the second user in the CAB server 206 and determines the users subscribing to the second user's contact information that should receive the updated contact information of the second user (e.g., the first user of the mobile terminal 200).

At step 216, CAB server 206 transmits an update information message to the CAB server 204 to provide the first user the updated contact information of the second user. At step 218, the first user's AB located in the CAB server 204 is updated to reflect the second user's updated contact information.

Once the second user's AB entry in the CAB server 204 is updated, the CAB server 204 generates a unique identifier associated with the current AB (e.g., a checksum value, a timestamp, a version number, etc.). The CAB server 204 then updates the AB of all devices that implement the CAB function with the current AB and its unique identifier. For example, the terminal 202 may be executing a CAB client application or a background process for a CAB client application at predetermined intervals. Accordingly, at step 220, the CAB server 204 transmits an update information message to the terminal 202, which updates the AB of the terminal 202 at step 222.

As noted above, because the mobile terminal 200 has limited resources, it is not desirable to continually execute a CAB application to synchronize with the AB on the CAB server 204. Accordingly, the CAB core functions are performed using the CAB agent on a different device in the user domain 105. In this example, the terminal 202 is also executing the CAB agent and the CAB server 204 is configured to synchronize with the CAB agent in lieu of synchronizing with the mobile terminal 200. Accordingly, because the CAB agent is executing, the CAB server 204 transmits an update information message to the CAB agent at step 224, thereby causing the CAB agent to update the AB for the mobile terminal 200 at step 226. Thus, at step 226, the CAB client application of the terminal 202 and AB agent have different ABs. The CAB agent performs the CAB core functions described above (e.g., eXtensible Markup Language (XML) processor, XML Configuration Access Protocol (XCAP) client, CAB logic device, Session Initialization Protocol (SIP) manager, etc.) on behalf of the mobile terminal 200. As noted above, messages may be sent to indicate successful reception of the transmitted information from the CAB server 204. In such an example, when the CAB agent transmits an ACK message to the CAB server 204 to indicate successful reception of the synchronization information, the CAB server 204 is under notice that the mobile terminal 200 will be updated via the CAB agent.

At step 228, the user executes the CAB application on the mobile terminal 200, which then transmits a start signal to the CAB agent at step 230 to indicate that the CAB application has initiated execution. To facilitate execution of the CAB application, an AB may be cached on the mobile terminal 200 and the start signal may contain a unique identifier associated with the cached AB (e.g., a checksum value, a timestamp, etc.).

In response to receiving the start signal, the CAB agent on the terminal 202 determines if the cached AB of the mobile terminal 200 needs to be updated based on the unique identifier at step 232. For example, if the unique identifier associated with AB in the CAB agent does not match the unique identifier in the start signal, an update of the AB of the mobile terminal 200 is required to synchronize its AB.

At step 234, the CAB agent generates the synchronization information based on the unique identifier in the start signal. In one example, the CAB agent may transfer the entire AB to the mobile terminal 200. In another example, the CAB agent may generate synchronization information that only changes AB information based on updates since the time of the last execution of the CAB application of the mobile terminal 200. In yet another example, the entire AB may be provided from the CAB agent if a predetermined time has passed between the last update to the AB of the mobile terminal 200. The terminal 202 may also retrieve the current AB direction from the CAB server 204 in response to the start signal.

After generating the synchronization information, at step 236 the CAB agent translates the synchronization information into a format suitable for the CAB application of the mobile terminal 200. That is, because the CAB core functions are processor intensive, the CAB agent translates the synchronization information into a format more convenient for the CAB application on the mobile terminal 200. For example, the CAB application may be implemented in a web Application Programming Interface (API) to allow transfer of data via HTTP. For instance, the CAB application of the mobile terminal 200 transmits data to and from the terminal 202 via a JavaScript Object Notation (JSON) data-interchange format that simplifies parsing of the received data on the mobile terminal 200.

The translated synchronization information is transmitted to the mobile terminal 200 at step 238. The mobile terminal 200 parses the translated information, generates the synchronization information, and updates the AB at step 240 using the synchronization information.

FIG. 2B illustrates a signal flow to synchronize a PCC of a mobile terminal 250 when using a different terminal 252 to update the user's contact information stored on a CAB server 256.

Initially, the CAB application of mobile terminal 250 is not being executed at step 258, which is when the user updates their contact information (e.g., address, phone number, social network identification, Instant Messenger (IM) identification, website, etc.) associated with their Personal Contact Card (PCC) in the terminal 252. The terminal 252 then determines a type of message to send to a terminal 254 having a CAB agent based on the updated contact information. At step 260, the terminal 252 transmits the update contact information message to the terminal 254, which updates the user's PCC at step 262.

After updating the user's PCC, the terminal 254 transmits a message to the CAB server 256 at step 264 to update the user's contact information (e.g., PCC), in the CAB server 256 at step 266. In this example, because the terminal 254 is executing the CAB agent, the CAB server 256 is under notice that the CAB agent will synchronize other devices associated with the user.

For instance, after the PCC is updated, the user executes a CAB application at step 268 and transmits a start signal to the CAB agent at step 270 to indicate that the CAB application has initiated execution. A PCC may be cached on the mobile terminal 250 and the start signal may contain a unique identifier associated with the cached PCC (e.g., a checksum value, a timestamp, etc.).

In response to receiving the start signal, the CAB agent on the terminal 254 determines if the cached PCC of the mobile terminal 250 needs to be updated based on the unique identifier at step 272. For example, if a unique identifier associated with the PCC in the CAB agent does not match the unique identifier in the start signal, an update of the PCC of the mobile terminal 250 is required to synchronize the PCC.

At step 274, the CAB agent generates the synchronization information based on the unique identifier in the start signal. In one example, the CAB agent may transfer the entire PCC to the mobile terminal 250. In another example, the CAB agent may generate synchronization information that only changes PCC information based on updates since the time of the last execution of the CAB application of the mobile terminal 250.

After generating the synchronization information, at step 276 the CAB agent translates the synchronization information into a format suitable for the CAB application of the mobile terminal 250. That is, because the CAB core functions are processor intensive, the CAB agent translates the synchronization information into a format more convenient for the CAB application on the mobile terminal 250. For example, the PCC application may be implemented in a web API to allow transfer of data via HTTP. For instance, the PCC application of the mobile terminal 250 transmits data to and from the terminal 254 via JSON.

The translated synchronization information is transmitted to the mobile terminal 250 at step 278. The mobile terminal 250 parses the translated information, generates the synchronization information, and updates the PCC at step 240 using the synchronization information at step 280.

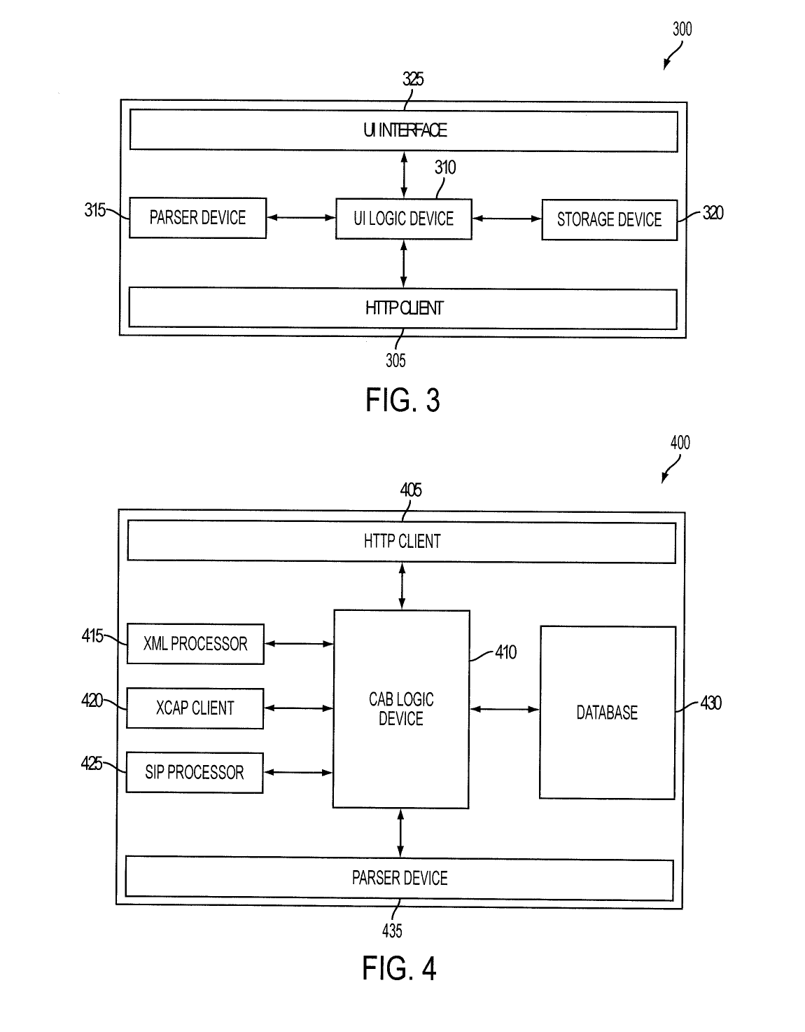

FIG. 3 illustrates a block diagram of an example CAB application 300 that is executed on a mobile terminal in conjunction with a CAB agent.

The CAB application 300 sends and data via an HTTP client 305 using any suitable communication function of the mobile terminal (e.g., IEEE 802.11(n), Bluetooth®, 3rd Generation Partnership Program (3GPP), etc.). The received data is passed to a User Interface (UI) logic device 310, which communicates with a parser device 315 for data processing. As noted in an example above, the parser device 315 converts the formatted data (e.g., JSON) into a format suitable for the UI logic device 310. The UI logic device 310 stores and retrieves data from a storage device 320 (e.g., a cache, a non-volatile storage memory, etc.). The CAB application 300 receives input from a UI interface 325, and the UI logic device 310 outputs AB information in response to the input via the UI interface 325.

FIG. 4 illustrates a block diagram of an example CAB agent 400 that is executed on a terminal in connection with a CAB application as described in FIG. 3.

The CAB agent 400 includes a HTTP client 405 for sending and receiving data associated with the mobile terminal (e.g., JSON data) and data associated with the CAB server (e.g., XML). The HTTP client 405 provides the data to a CAB logic device 410, which transmits and receives data from an XML processor 415 to perform general XML processing functions. The CAB logic device 410 is configured to send and receive XCAP data using an XCAP client 420 for management of XML configuration data. A Session Initiation Protocol (SIP) processor 425 handles document subscriptions and notification services and a database 430 stores and retrieves data of the CAB agent 400.

As noted above, the CAB logic device 410 is configured to send and receive data in a format suitable for the CAB application using a parser device 435, which can parse the received data from the CAB application and translate the received data suitable for use in the CAB agent 400. Likewise, the parser device 435 can translate data in the CAB agent 400 into a format suitable for the CAB application.

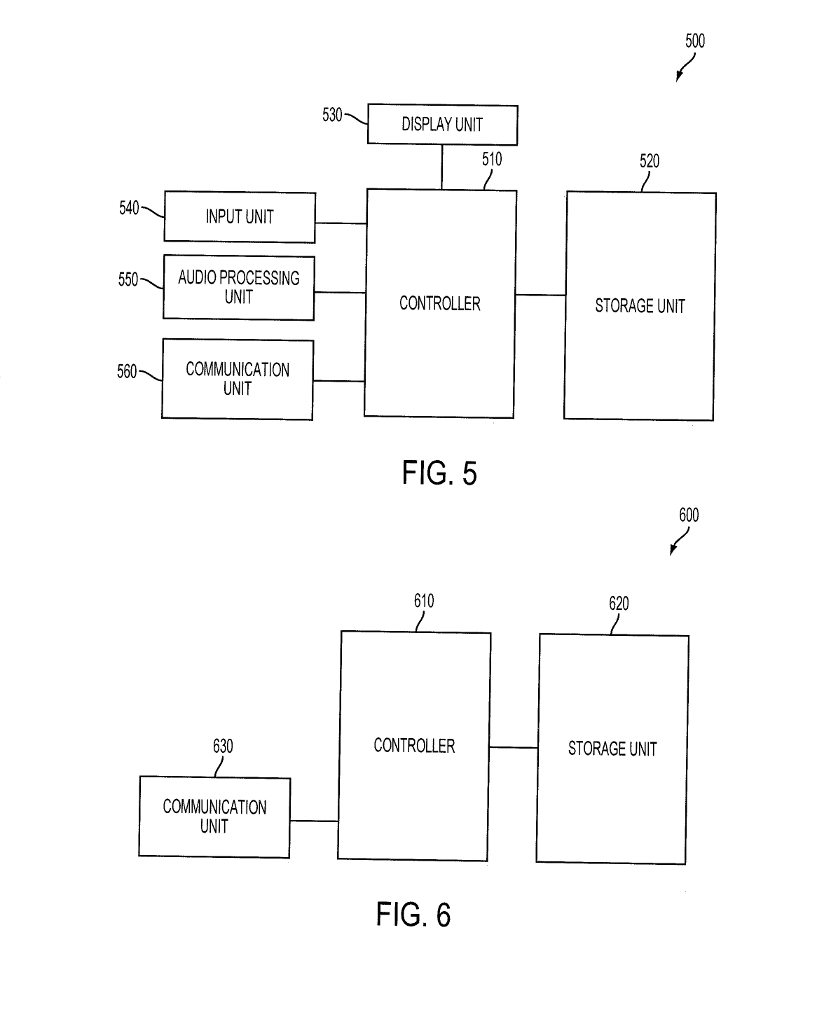

FIG. 5 is block diagram schematically illustrating a configuration of a mobile terminal according to an exemplary embodiment of the present invention.

Referring to FIG. 5, a mobile terminal 500 according to an exemplary embodiment of the present invention includes at least one controller 510, a storage unit 520, a display unit 530, an input unit 540, an audio processing unit 550, and a communication unit 560. As an example, the mobile terminal 500 having such a configuration may store at least one CAB application for displaying and editing an AB in connection with a CAB agent. For example, the CAB application may be configured to receive synchronization information from the CAB agent and update the AB of the mobile terminal 500 when a user initiates execution of the CAB application.

According to exemplary embodiments of the present invention, the mobile terminal 500 may further include various sensors for determining the environment. For example, the mobile terminal may include a Global Positioning System (GPS) sensor for determining the location of the mobile terminal. The mobile terminal may also include a date and time sensor.

Hereinafter, each component of the mobile terminal 500 will be explained in detail.

The communication unit 560 is configured to send and receive communication with various devices using various communications techniques. For example, the communication unit includes a Bluetooth® function, an IEEE 802.11(n) function, an Ethernet function, and a 3GPP communication function to communicate with different devices. According to exemplary embodiments of the present invention, the communication unit 560 receives synchronization information from a CAB agent to synchronize the AB of the mobile terminal 500.

The audio processing unit 550 may be formed as an acoustic component. The audio processing unit 550 transmits and receives audio signals, and encodes and decodes the audio signals. For example, the audio processing unit 550 may include a coder-decoder (codec) and an audio amplifier. The audio processing unit 550 is connected to a Microphone (MIC) and a Speaker (SPK). The audio processing unit 550 converts analog voice signals inputted from the Microphone (MIC) into digital voice signals, generates corresponding data for the digital voice signals, and transmits the data to the controller 510. Further, the audio processing unit 550 converts digital voice signals inputted from the controller 510 into analog voice signals, and outputs the analog voice signals through the Speaker (SPK). Further, the audio processing unit 550 may output various audio signals generated in the mobile terminal 500 through the Speaker (SPK). For example, the audio processing unit 550 can output audio signals according to an audio file (e.g. MP3 file) replay, a moving picture file replay, and the like through the speaker.

The input unit 540 may include input keys and function keys for receiving user input. For example, the input unit 540 may include input keys and function keys for receiving an input of numbers or various sets of letter information, setting various functions, and controlling functions of the mobile terminal 500. For example, the input unit 540 may include a calling key for requesting a voice call, a video call request key for requesting a video call, a termination key for requesting termination of a voice call or a video call, a volume key for adjusting output volume of an audio signal, a direction key, and the like. In particular, the input unit 540 according to exemplary embodiments of the present invention may transmit to the controller 510 signals related to an input for viewing an AB, editing contact information of the user, or initiating contact with a person listed in the AB. Further, according to exemplary embodiments of the present invention, the input unit 540 may transmit to the controller 510 signals relating to selection of an AB entry to display more information of the AB entry, edit the AB entry, delete the AB entry, or request a new AB entry, for example. As another example, the user may use the input unit 540 initiate execution of the CAB application. Such an input unit 540 may be formed by one or a combination of input means such as a touch pad, a touchscreen, a button-type key pad, a joystick, a wheel key, and the like.

The display unit 530 displays information inputted by user or information to be provided to user as well as various menus of the mobile terminal 500. For example, the display unit 530 may provide various screens according to a user of the mobile terminal 500, such as an idle screen, a message writing screen, a calling screen, and the like. In particular, the display unit 530 according to exemplary embodiments of the present invention can display a CAB application for displaying of an AB on the mobile terminal 500. As an example, the display unit 530 can output an interface with which a user may view the AB and the entries in the AB. For example, the display unit 530 may display an interface which the user may manipulate or otherwise enter inputs via a touch screen to enter inputs for selecting and viewing an AB entry on the mobile terminal 500. The display unit 530 can be formed as a Liquid Crystal Display (LCD), an Organic Light Emitting Diode (OLED), an Active Matrix Organic Light Emitting Diode (AMOLED), and the like. However, exemplary embodiments of the present invention are not limited to these examples. Further, the display unit 530 can perform the function of the input unit 540 if the display unit 530 is formed as a touch screen.

The storage unit 520 can store user data, and the like, as well a program which performs operating functions according to an exemplary embodiment of the present invention. For example, the storage unit 520 may store a program for controlling general operation of a mobile terminal 500, an Operating System (OS) which boots the mobile terminal 500, and application program for performing other optional functions such as an AB function, a camera function, a sound replay function, an image or video replay function, a Near Field Communication (NFC) function, and the like. Further, the storage unit 520 may store user data generated according to a user of the mobile terminal, such as, for example, a text message, a game file, a music file, a movie file, and the like. In particular, the storage unit 520 according to exemplary embodiments of the present invention may store an AB corresponding to an AB that is updated when the CAB application is executed.

According to exemplary embodiments of the present invention, the mobile terminal 500 comprises at least one controller 510. The at least one controller 510 may control general operation of the mobile terminal 500. For example, the controller 510 may control operation of the various components or units included in the mobile terminal 500. The controller 510 may transmit a signal to the various components included in the mobile terminal 500 and control a signal flow between internal blocks of the mobile terminal 500. In particular, the controller 510 according to exemplary embodiments of the present invention can control synchronization of an AB of the when the CAB application is executed via the input unit 540. To this end, the controller 510 may transmit unique information corresponding to the stored AB to a CAB agent, which determines if the AB of the mobile terminal 500 should be updated. In the case that the AB should be updated, the CAB agent transmits the synchronization information and the controller 510 updates the AB based on the synchronization information. The controller 510 may also be configured to parse data into a format suitable for the CAB application.

FIG. 6 is block diagram schematically illustrating a configuration of a terminal 600 according to an exemplary embodiment of the present invention.

Referring to FIG. 6, the terminal 600 according to an exemplary embodiment of the present invention includes at least one controller 610, a storage unit 620, and a communication unit 630. In some examples, the terminal 600 may include a display unit (not shown) for display of information and an input unit (not shown) to receive input from a user. As an example, the terminal 600 having such a configuration in a user domain is configured execute a CAB agent that synchronizes an AB of the mobile terminal with a server associated with a network carrier.

Hereinafter, each component of the terminal 600 will be explained in detail.

The communication unit 630 is configured to send and receive communication with various devices using various communications techniques. For example, the communication unit includes a Bluetooth® function, an IEEE 802.11(n) function, an Ethernet function, and a 3GPP communication function to communicate with different devices. According to exemplary embodiments of the present invention, the communication unit 630 receives update information from an AB server that stores an AB of the user, the AB being synchronized with multiple user devices.

The storage unit 620 is configured to store applications for execution on the terminal 600 and data associated with the stored applications. For example, a CAB application may be stored in the storage unit 620 to allow the terminal 600 to execute and perform the AB functions associated with an AB stored in the storage unit 620. A CAB agent may also be stored in the storage unit 620 to allow the terminal 600 to synchronize the AB another terminal with a central AB (e.g., the AB of the terminal 600, an AB of a CAB server, etc.).

According to exemplary embodiments of the present invention, the terminal 600 comprises at least one controller 610. The at least one controller 610 may control general operation of the terminal 600. For example, the controller 610 may control operation of the various components or units included in the terminal 600. The controller 610 may transmit a signal to the various components included in the terminal 600 and control a signal flow between internal blocks of the terminal 600. For instance, the terminal 600 may execute a CAB application or a CAB agent stored in the storage unit 620. The CAB agent may cause the controller 610 to receive a start signal from a mobile terminal when a CAB application on the mobile terminal is executed. Further, the CAB agent being executed on the terminal 600 may synchronize the AB of the mobile terminal with a CAB associated with the terminal 600 (e.g., a stored AB, a remote AB, etc.) in response to the start signal.

According to exemplary embodiments of the present invention, the CAB agent is executed in an environment outside of the carrier domain, and allows a CAB application of a mobile terminal to be updated when executed. The exemplary CAB core functions of the CAB application of the mobile terminal are therefore offloaded to the terminal 600 to allow a mobile terminal implement to a lightweight CAB application that can maintain its AB synchronization. That is, the CAB application provides the user interface for the CAB client, but the CAB agent performs the bulk of the processing as required to implement the CAB client (e.g., generating a search request, managing subscriptions, XML processing, etc.).

An enterprise CAB client according to exemplary embodiments of the present invention may be implemented in an executable program command form by various computer means and be recorded in a non-transitory computer readable recording medium. The computer readable recording medium may include a program command, a data file, and a data structure individually or a combination thereof. The program command recorded in a recording medium may be specially designed or configured for exemplary embodiments of the present invention, or may be known to a person having ordinary skill in the art.

The computer readable recording medium includes Magnetic Media such as hard disk, floppy disk, or magnetic tape, Optical Media such as Compact Disc Read Only Memory (CD-ROM) or Digital Versatile Disc (DVD), Magneto-Optical Media such as floptical disk, a hardware device such as ROM, RAM, flash memory storing and executing program commands, and the like. Further, the program command includes a machine language code created by a compiler and a high-level language code executable by a computer using an interpreter. The foregoing hardware device may be configured to be operated as at least one software module to perform an operation of exemplary embodiments of the present invention.

While the invention has been shown and described with reference to certain exemplary embodiments thereof, it will be understood by those skilled in the art that various changes in form and details may be made therein without departing from the spirit and scope of the invention as defined by the appended claims and their equivalents.

Although certain methods, systems, and articles of manufacture have been described herein, the scope of coverage of this patent is not limited thereto. To the contrary, this patent covers all methods, systems, and articles of manufacture fairly falling within the scope of the appended claims either literally or under the doctrine of equivalents.

What is claimed is:

1. A method of synchronizing an address book in a mobile terminal with an address book in a server, the method comprising:
upon initiation of execution of an address book application in a mobile terminal, transmitting a start signal having an address book identification to an address book agent;
in response to the start signal, receiving synchronization information for synchronizing an address book of the address book application, the synchronization information being generated by the address book agent in response to update information from an address book server; and
synchronizing the address book of the application using the synchronization information.

2. The method of claim 1, wherein the address book server comprises a Converged Address Book (CAB) server.

3. The method of claim 2, wherein the CAB server synchronizes an address book on another terminal when the address book application is not being executed on the mobile terminal.

4. The method of claim 2, wherein the address book agent generates synchronization information based on update information received at the address book server, the synchronization information including updates to the address book from a point the application stopped execution to a point of receiving the start signal.

5. The method of claim 2, wherein the address book agent performs CAB core functions on another terminal and the address book application provides a user interface to the CAB core functions for a user of the mobile terminal.

6. The method of claim 2, wherein the address book agent continues to perform the CAB core functions for the mobile terminal when the address book application on the mobile terminal is stopped.

7. The method of claim 2, wherein, in response to the update information, the address book agent transmits signals back to the server to indicate updates to the address book on the mobile terminal.

8. The method of claim 2, wherein the CAB server is operated by a wireless carrier.

9. The method of claim 8, wherein the address book agent is operated by an entity other than the wireless carrier.

10. A method of synchronizing an address book in a mobile terminal with an address book in a server, the method comprising:
receiving a request to update at least one address book of a first user at an address book server, the request including updated contact information of a second user;
determining if a mobile terminal of the first user provides an address book agent for receiving the updated contact information of the second user; and
transmitting the updated contact information of the second user from the address book server to the address book agent,
wherein the address book agent is configured to translate the updated contact information into synchronization information suitable for an address book application on a mobile terminal and transmit the synchronization information to the mobile terminal in response to a user initiating execution of the address book application on the mobile terminal.

11. The method of claim 10, wherein the address book server comprises a Converged Address Book (CAB) server.

12. The method of claim 11, wherein the CAB server synchronizes an address book on another terminal when the address book application is not being executed on the mobile terminal.

13. The method of claim 11, wherein the address book agent generates synchronization information based on update information received at the address book server, the synchronization information including updates to the address book from a point the address book application stopped execution to a point of receiving the start signal.

14. The method of claim 11, wherein the address book agent performs CAB core functions and the address book application provides a user interface to the CAB core functions for a user of the mobile terminal.

15. The method of claim 11, wherein the address book agent continues to perform the CAB core functions when the address book application on the mobile terminal is stopped.

16. The method of claim 11, wherein, in response to the update information, the address book agent transmits signals back to the CAB server to indicate updates to the address book on the mobile terminal.

17. The method of claim 11, wherein the CAB server is operated by a wireless carrier.

18. The method of claim 17, wherein the address book agent is operated by an entity other than the wireless carrier.

19. An apparatus for synchronizing an address book in a mobile terminal with an address book in a server, the apparatus comprising:
a communication unit for sending and receiving data from at least one communication network;
a storage unit for storing an address book and an address book application;
an input unit for receiving input from a user to control the address book application; and
a controller for initiating executing the address book application in response to input from the user,
wherein the address book application transmits a start signal to a terminal having an address book agent in response to initiating executing of the address book application,
wherein the address book agent determines if the address book needs to be synchronized with an address book in a server, and
wherein the server is associated with a network entity and the terminal is associated with a different entity.

20. The apparatus of claim 1, wherein the address book server comprises a Converged Address Book (CAB) server.
